(19) United States
(12) Patent Application Publication
(10) Pub. No.: US 2015/0089347 A1
(43) Pub. Date: Mar. 26, 2015

(54) CALENDAR APPARATUS HAVING ANNUAL CODE ASSOCIATED WITH DATE

(71) Applicant: PALOALTOCODE INC., TOTTORI-PREFECTURE (JP)

(72) Inventor: TORU SATO, TOTTORI-PREFECTURE (JP)

(73) Assignee: PALOALTOCODE INC., TOTTORI-PREFECTURE (JP)

(21) Appl. No.: 14/139,968

(22) Filed: Dec. 24, 2013

(30) Foreign Application Priority Data
Sep. 24, 2013 (JP) 2013-196505

(51) Int. Cl. G06F 17/24

(52) U.S. Cl. CPC G06F 17/245
USPC 715/227

(57) ABSTRACT

[Subject] The usefulness of calendar apparatus which matched annual code with date is improved.

[Solution means] Monthly sheet processing means which makes daily records correspond to annual code and date, and indicates by list, annual sheet processing means which indicates clickable annual code button by list, the first day of the code setup means which sets first day of the code as the days and months which a user wishes while displaying that which started processing and with which it already registered of daily records by clicking annual code button, daily records processing means which processes initial registration and renewal registration, a search is performed to daily records and it has record search means which makes the search results correspond to annual code and date, and displays them. It has the correspondence relation between annual code and date as a correspondence table of annual code and date. It has the correspondence relation between date and daily records as a correspondence table of date and daily records.

### BACKGROUND OF INVENTION

1. Field of Invention

Calendar apparatus is realized by application software installed in a stand-alone type computer. Or it is related with calendar apparatus realized by two or more computers which cooperate by computer network and operate. In two or more computers which cooperate by computer network and operate, for example, ASP (application service provider) server on the Internet, the case where personal computer (or mobile phone, a handheld device machine) cooperates and functions using the technology of cloud computing is included.

2. Description of Related Art

In prior art 1 (JPO laid-open 2002-200866, title of the invention: A calendar with date and number), a calendar begins January 1 as the 0th day or the 1st day every year, and ends December [of the same year] 31 as the 364th day or the 365th day. Or, it begins January 1 from the 364th day or the 365th day every year, and it makes December [of the same year] 31 into the 0th day or the 1st day date on which the calendar begins. The specific memorial day which were written as the 0th day or the 1st day as specific date, is chosen by a user freely. The date and days are written together. Or, a memorial day—as specific date—the date which was begun and was freely specified from X−1 day or the Xth day is made into the 0th day or the 1st day. Calendar which writes together the date and days is indicated.

In prior art 2 (JPO laid-open 2001-167182, title of the invention: Funeral information input device and program storable media), the funeral form used as that which changes with religion is chosen, and the technology constituted so that the schedule information on a funeral ceremony might be inputted is indicated using the calendar screen which has a ceremony name suitable for the funeral form as an input item. According to this composition, simultaneously with it, it can input into server by making the schedule information on that determined funeral applicable to a notice, a mortician, a chief mourner, etc. deciding on a funeral schedule. Therefore, while being able to put up exact funeral information, the work which funereal preparation takes can be done efficiently.

### SUMMARY OF INVENTION

One or more embodiments of the claimed invention enhances the value of the calendar apparatus having annual code associated with date.

Be Realized by Software

In this specification, “be realized by software” means that the CPU (central processing unit) reads the computer program memorized by the memory storage of computer if needed, and performs processing, i.e. hardware (computer apparatus) and software (computer program) cooperate, and realize a function. When ASP server on the Internet and a user's handheld device machine cooperate and function with the technology of cloud computing, software required for each of server and user's is installed, respectively. And when a user operates a handheld device machine, software on ASP server starts a function, acts mutually, and realizes a function.

Annual Code

“Annual code” means the code which made the 1st day the specific day (for example, March 1 [Although which day may be sufficient]) of the one year, and was assigned to all the dates. When setting up “1” of annual code on March 1, it is assigned one by one as annual code “2” is assigned on March 2, and annual code “365” is assigned on next year February 28. The same annual code is assigned to the same date of other years. In this meaning, annual code is the code in a cycle of one year, and is a code suitable for managing the event performed every year following the time-honored custom.

“Annual code button” is button which displays annual code, and is clickable.

“First day of the code” means the specific date to which annual code “1” is assigned. It is in the upper example “March 1”. A user can change first day of the code flexibly, and sets up and uses it according to the occasional purpose of the user. On a first day of the code setting screen, the day and month on which the user wants to set up first day of the code are chosen or inputted. For example, matching with date and annual code is updated by choosing the month March, and choosing the 1st day, and pushing updating button. This matching is realizable by having a table which matches annual code and date.

First day of the code can be set up freely. For example, it can be set to Founder's Day of a company, the day when a fiscal year begins, the day which the project launched, the day when construction begins, etc. In addition to when starting to use this calendar apparatus, it can set up any number of times if needed also ex post. First day of the code is set to January 1 by default (when a user does not do the descriptive procedure of first day of the code).

Daily Records

“Daily records” fill in the occurrence (or planning event) which occurred (or is planned) on that day, and its contents, and means the recorded contents of record. For example, it divides into a title and the contents and it records an occurrence. Daily records of two or more affairs can be registered about the same date.

Daily record screen is a screen for carrying out initial registration of daily records for every specific date. The already inputted contents of record are also collectively displayed on the registration screen. It is for avoiding and inputting duplication.

Annual code button is prepared in some screens used for calendar apparatus of this invention. If the user clicks one of them, the screen will move (change) to the corresponding registration screen (daily record screen) of daily records of date. The contents of registered daily records are managed as a table (or database) matched with date.

### Record Search

“Record search” is processing which performs a search (for example, text browsing) to the contents recorded as daily records, and displays the result. It starts by clicking record search button prepared in monthly sheet or daily record screen. If a user inputs a keyword and clicks search button, calendar apparatus will perform a search to daily records, daily records containing the keyword is listed with annual code and a the date, and search results are displayed. Even in a case where dates of search results straddles some months, the number of days between two or more events (occurrence) are easily calculable in reliance on annual code matched with them. If the user moves to annual sheet, clicks the button of first day of the code setting processing, and reset up first day of the code, this day count will become easier. What is necessary is just to reset the date of the earlier one as first day of the code among two occurrences of wanting a day count.

“Search result sheet” is a screen which displays the result of having performed record search. When a user wants, a file output is carried out and a user makes acquisition possible.

### Monthly Sheet

“Monthly sheet” is a screen which specifies a year and the month, displays the contents of daily records contained in the month in order of the date, and displays annual code collectively. The display of each annual code in monthly sheet is annual code button (clickable button). In addition to this, monthly sheet is provided with the column in which a memo input is possible. It is useful when the user wants to input memo, without specifying the date, or when the user wants to exclude operation until it results in the date which should be inputted, and input in a hurry.

The column which can carry out a memo input can also carry out proper use. For example, a user can input the schedule of the future into the memo 1 and input the past record into the memo 2.

Like the above-mentioned search result sheet, when a user wants, a file output of the monthly sheet is carried out and a user makes acquisition possible. Moreover, monthly sheet is provided with button which enables movement to next month and the previous month respectively, button which enables movement to annual sheet, and button of record search processing.

### Annual Sheet

“Annual sheet” is the screen which specifies a certain year and displays all the annual code through every month. A list indication of annual code from first day of the code to the final code of the year (“365” or “366”), i.e., the previous day of first day of the code belonging to the next year, is given. The display of each annual code in annual sheet is above-mentioned annual code button (clickable button).

### How to Use

This apparatus can be used as a schedule book, a diary, a calendar, and a self-reflection tool. Moreover, it can be used for process control on a construction site, the progress management of a project, a business log, a logbook, etc. Furthermore, it can be used as a tool (compiling tool) into which an autobiography, a chronicle, Annals, a company history, etc. are edited.

First, how to use in the case of using as a self-reflection tool is explained. It is assumed that the user of this calendar apparatus has participated in the annual event over several years every year using this equipment. When looking back upon several years and reflecting on whether the preparation period was enough about a certain specific event this year, the user calculates by analyzing the days which the preparation about that event this year took using this apparatus. The proposal to next year can be performed as a reflection material by analyzing similarly, and comparing and contrasting with three-year and four-year before last year and the year before last.

Next, an example of how to use in the case of using as progress management of a project is explained. Since “daily records” is divided into a title and its detailed contents, the apparatus can carry out usage of inputting a schedule into the title column and inputting an actual result into the column of detailed contents. Since search results can be taken out using a search service even if it is a long project of a period over two or more months, the days of a schedule and the days of a result are comparable in reliance on annual code. It enables to form the policy which makes up for delay.

Furthermore, the case where a user uses this apparatus as an autobiography creation supportive tool is explained. Usually, if someone tries to write an autobiography, he or she has to examine the diary also covering tens of volumes in detail, and chooses carefully the portion which should be extracted. Such work can be done easy at the user who used calendar apparatus concerning this invention over tens of years. It is because search which exceeded years by using a search service can be performed. Moreover, it becomes easy to investigate exceeding a year by making full use of the previous year button and the next year button at annual sheet.

In the case where a company history is edited etc., since many annual events occur every year, the one-year periodicity of annual code can be utilized in investigating.

### The Effect of Invention

The day count over two or more months from a specific day to another specific day can be performed easily, using annual code.

It becomes easy to carry out schedule management by setting the starting day of a project as the first day of annual code.

The passage of the time of thinking is not interrupted by pause of the month. Continuity can be given to thinking.

If the number which counts date is divided by 1 to 30 (or 31), it will be interrupted while the passage of the time in man's head does not know.

The long thinking of time span in which the user can think is attained by using annual code. The user can think in the time-axis. The thinking is not broken off. Continuing way of thinking is attained.

Thinking on a global scale, not only the calendar of A.D. but various calendars are used. Also among those people who use other calendars, to have the passage of common time becomes possible by having annual code in common.

The apparatus is useful to associate the occurrence for one year.

The next deployment can be conceived by relating the ideas with annual code and arranging it.

By matching date with annual code, information integration can be carried out and it can connect to the way of thinking and a flash.

### BRIEF EXPLANATION OF THE DRAWINGS

FIG. 1 is a figure showing the hardware composition of calendar apparatus. FIG. 1 (a) shows the composition in stand-alone type. FIG. 1 (b) shows the case where it is constituted by two or more computers which cooperate by network.

FIG. 2 is a figure explaining the composition of software, and two tables. FIG. 2 (a) is a figure which regarded each portion which constitutes software as two or more means, and enumerated it. FIG. 2 (b) is a figure showing the correspondence table between annual code and date. FIG. 2 (c) shows the correspondence table showing the relation between date and daily records.

FIG. 3 is a figure explaining screen changes. FIG. 3 (a) shows the table showing whether each screen is equipped with button which can move to which screen about main screens. FIG. 3 (b) is a screen transition diagram drawn about movement from each screen on other screens using the arrow.

FIG. 4 (c) shows the display screen which shows the example of monthly sheet displayed when the user succeeds in login. FIG. 4 (a) shows log in screen. FIG. 4 (b) shows an error screen.

FIG. 5 shows the confirmation screen in the case of carrying out the memo input prepared in monthly sheet. FIG. 5 (a) shows the screen which asks a user whether to cancel registering, after a memo input. FIG. 5 (b) shows the confirmation screen which tells a user having registered.

FIG. 6 shows the screen about annual sheet and first day of the code setting processing. FIG. 6 (a) shows annual sheet in the 2013 year about the case where first day of the code is on March 1. FIG. 6 (b) shows a first day of the code setting screen. FIG. 6 (c) shows the screen which tells a user that renewal of first day of the code was registered.

FIG. 7 shows the screen about the input process of daily records. FIG. 7 (a) shows daily record screen about date into which daily records of two affairs was already registered. FIG. 7 (b) shows daily record screen at the time of inputting daily records of the 3rd affair. FIG. 7 (c) shows the screen displayed when addition button is clicked, after inputting the contents which ask for initial registration. FIG. 7 (d) shows the screen which updates already inputted daily records. FIG. 7 (e) shows the screen which checks renewal registration.

FIG. 8 shows the screen in which monthly sheet after inputting daily records is shown.

FIG. 9 shows the screen about record search processing. It is a screen for FIG. 9 (a) inputting a keyword and performing search processing, and FIG. 9 (b) shows the screen which displays search results.

FIG. 10 is a flow chart which shows login processing.

FIG. 11 is a flow chart which shows a display and memo input process of monthly sheet.

FIG. 12 is a flow chart which shows annual sheet processing, and a flow chart which shows first day of the code setting processing.

FIG. 13 is a flow chart which shows the input process of daily records.

FIG. 14 is a flow chart which shows processing of record search.

### DESCRIPTION OF PREFERRED EMBODIMENTS

Hereinafter, the suitable case of the embodiments of this invention is described in detail, referring to drawings.

### About Hardware Composition

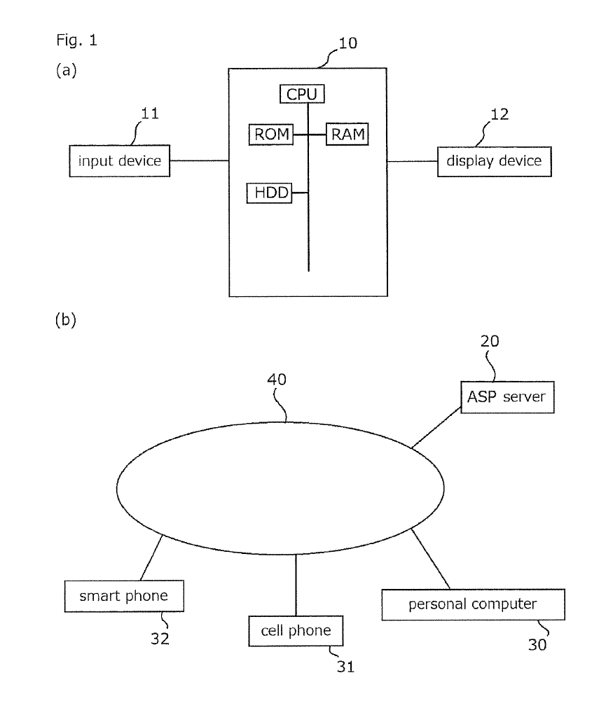

FIG. 1 is a block diagram showing the hardware composition of calendar apparatus. FIG. 1 (a) shows the case where stand-alone type computer constitutes calendar apparatus of this invention. FIG. 1 (b) shows the case where two or more computers which cooperate by computer network and operate constitute calendar apparatus.

Stand-alone type computer 10 of FIG. 1 (a), comprises CPU (central processing unit), ROM (read only memory), RAM (random access memory), HDD (hard disc drive), etc., and processing is performed based on the contents which the user inputted using the input device 11, and the processing result is displayed on the display 12, and is outputted. A keyboard and a mouse may be sufficient as the input device 11. Moreover, lamination arrangement of the input device 11 may be carried out with the display 12 as input devices, such as a touch panel, and you may constitute as what is called a tablet computer. Calendar apparatus of this invention is mainly realized by software. Computer program as application software is memorized by HDD, and is read into CPU if needed. Moreover, a part of program concerned, the data in the middle of processing, etc. are written in RAM. Thus, processing for realizing calendar apparatus of this invention by a program being run is performed.

FIG. 1 (b) shows the case where two or more computers which cooperate by computer network and operate constitute calendar apparatus. Computer network in FIG. 1 (b) is the Internet 40. ASP (application service provider) server 20 is connected to the Internet 40. ASP server 20 is equipped with calendar apparatus concerning this invention as application software. The user who has the authority to be used uses handheld device machines, such as personal computer 30, mobile phone 31 (cell phone), and smart phone (smart phone)32, through the Internet 40, the device connects with ASP server 20, and logs in and uses for it. It is possible to use the function concerned the same with the application software concerned being carried in the apparatus to which he owns a user with the so-called technology of cloud computing. For example, it is possible to create application program which starts this invention using PHP (web application development language) and MYSQL (database), and to operate it.

Furthermore, it is also possible to offer calendar apparatus which manages the project in which two or more persons are engaged. In such a case, it is convenient to use cloud computing.

The output of calendar apparatus concerning this invention is mainly displaying to the display screen of a user's handheld device machine. In addition, the done search-results screen or monthly sheet is file-ized, and a user may enable it besides, to acquire in download or mail attachment.

Although FIG. 1 (b) showed the case where network was built between ASP server on the Internet, and a user's handheld device machine, it is good also as same composition by what is called in-company LAN (intranet system) in the company.

If it is in cloud computing and a user connects with ASP server through network, ASP server will display the screen to which the next input is urged to a user's terminal equipment. If a user does the next input, it is sent to ASP server, and in ASP server, the information will process by performing application program, and will display the processing result on a user's terminal equipment. These exchanges are repeated. Hereinafter, making reference about the operation about the case of the cooperation on network is omitted, and explaining is focused on the contents of application program.

### About Software Composition

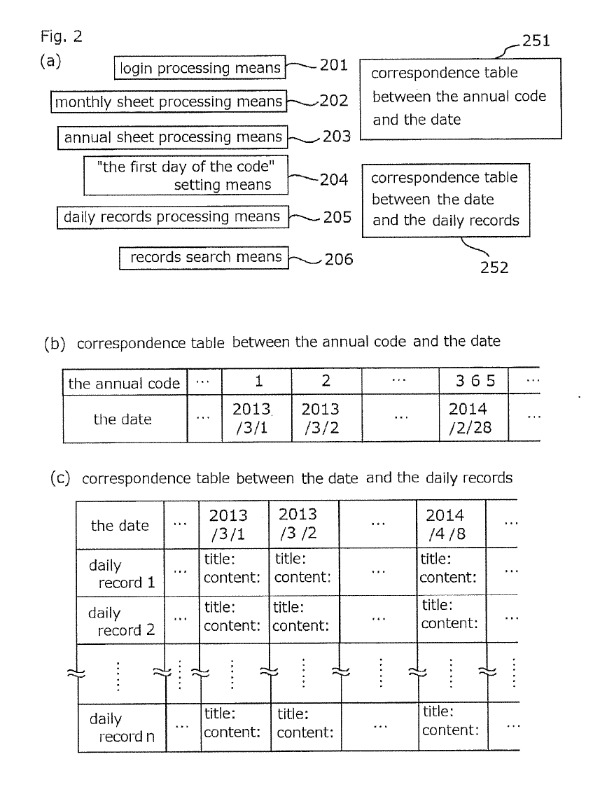

FIG. 2 is a figure explaining the composition of application program, and two tables. FIG. 2 (a) shows composition when application program, which constitutes calendar apparatus of this invention is regarded as consisting of two or more parts. As parts of program, it has six means: login processing means 201, monthly sheet processing means 202, annual sheet processing means 203, and first day of the code setting means 204, daily records processing means 205, and record search means 206. Moreover, two tables shown in FIG. 2 (b) cooperate, and the application program functions as calendar apparatus of this invention.

Login processing means 201 is means which checks that a user has the authority using this application program by the input of ID (user name) and a password. A user's input of them will attest a user's authority with reference to the conversion table (illustration is omitted) of a user name and a password. It displays monthly sheet, in being in agreement, and use of application program is urged. It urges that display an error screen in not being in agreement, and a user does an input again.

Monthly sheet processing means 202, when login was successful, or when the movement button to monthly sheet is clicked in other screens, creates the screen displayed so that annual code, date (and day of the week), and daily records of the specific month (to which today belongs, at the time of login) can be looked through, and performs processing shown to a user. Moreover, monthly sheet is equipped with the memo column and monthly sheet processing means 202 also performs processing that a user inputs into the memo column. The contents inputted into the memo column are memorized in a storage area and read whenever monthly sheet (illustration is omitted) is displayed.

Annual sheet processing means 203 performs processing which displays annual sheet, and the processing which moves to each screen, when a user clicks each button displayed on the annual sheet.

First day of the code setting means 204 is means which performs the processing, when a user wants to set up first day of the code if needed. By clicking the first day of the code setup button prepared on annual sheet, the screen moves to a first day of the code setting screen, and this processing starts.

Daily records processing means 205 performs processing which displays already inputted daily records, and initial registration processing and renewal registration processing.

Record search means 206 performs performing a search to already inputted daily records, and processing which displays the search results. Moreover, desirably, the file output of the search results is carried out, and it provides for a user.

The correspondence table 251 between annual code and date matches from annual code 1 to 365 (366) with date, as shown in FIG. 2 (b). By the diagram, it is attached and shown from Mar. 1, 2013 to Feb. 28, 2014. Desirably, it will attach from Jan. 1, 1901 to Dec. 31, 2199, for example, and annual code is matched with the cycle of one year. This table is a table to which is referred from five means 202 to 206 among six means mentioned above except login processing means 201.

The correspondence table 252 between date and daily records, As shown in FIG. 2 (c), is made to correspond to date (for example, each day from Jan. 1, 1901 to Dec. 31, 2199), and daily records 1, daily records 2, - - - , daily records n (n is an integer) are matched. Each daily record is divided into a title and the contents, and record is made. Among six means mentioned above, three means—monthly sheet processing means 202, daily records processing means 205, and record search means 206—refer to this table.

### [Screen Changes]

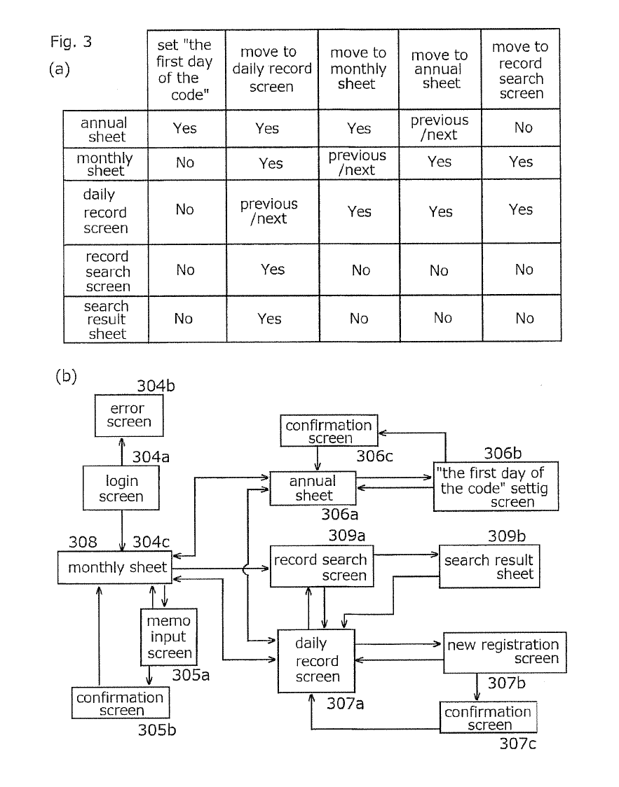

FIG. 3 is a figure explaining screen changes. FIG. 3 (a) shows the table showing whether each of five typical screens used for calendar apparatus has any of the movement button to other screens. Five typical screens are annual sheet, monthly sheet, daily record screen, a record search screen, and a search-results sheet. Seen horizontally about annual sheet, specifically, “The first day of the code setup button”, “the movement button to daily record screen”, the “movement button to monthly sheet”, and the “movement button to annual sheet” are prepared, and there is no movement button to a record search screen. Here, the movement button to annual sheet from annual sheet has referred to “the movement button to the previous year”, and the “movement button to the next year.”

Moreover, seen perpendicularly about “the first day of the code setup button”, it turns out that it is prepared in “annual sheet”, and is not prepared in other screens. Since annual code changes a correspondence relation with date by first day of the code setup, it is called for that a user performs prudent operation. Therefore, “the first day of the code setup button” is formed only in annual sheet.

Furthermore, seen perpendicularly about “the movement button to annual sheet”, from “monthly sheet” and from “daily record screen” screen change is possible. Seen perpendicularly about “the movement button to daily record screen”, it turns out that it is prepared in all five screens. Button of “annual code” is prepared in all the five screens, and it is clickable.

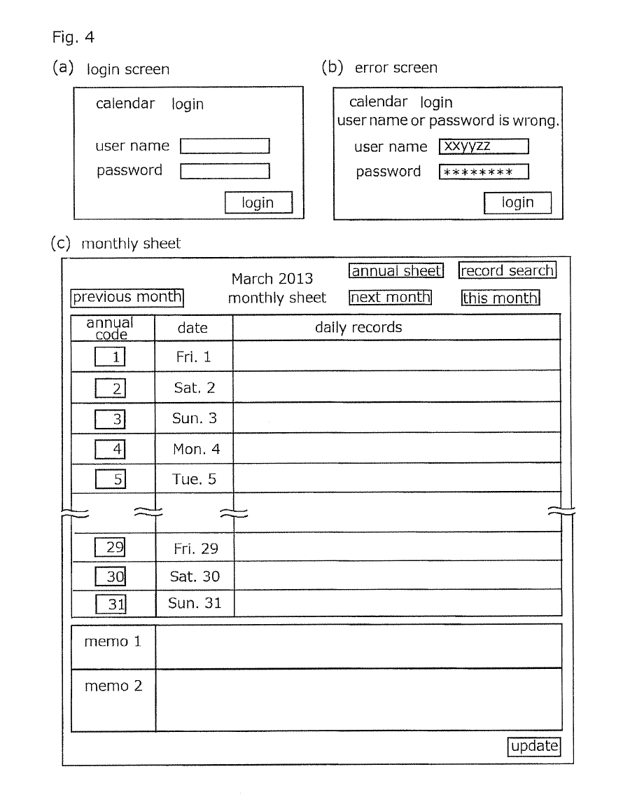

FIG. 3 (b) shows the possibility of screen changes by connecting with an arrow about the screen of 12 including five above-mentioned screens. That the arrow has become bi-directionally means that it can move to either both, between the two screens. A one of the two-oriented arrow means that movement of only one way is possible. Moreover, the mark given to each screen in FIG. 3 (b) is made to correspond to the figure number after FIG. 4. For example, having attached the mark 304 b about the error screen of login, means that the drawing concerned is shown in FIG. 4 (b).

### Login Process

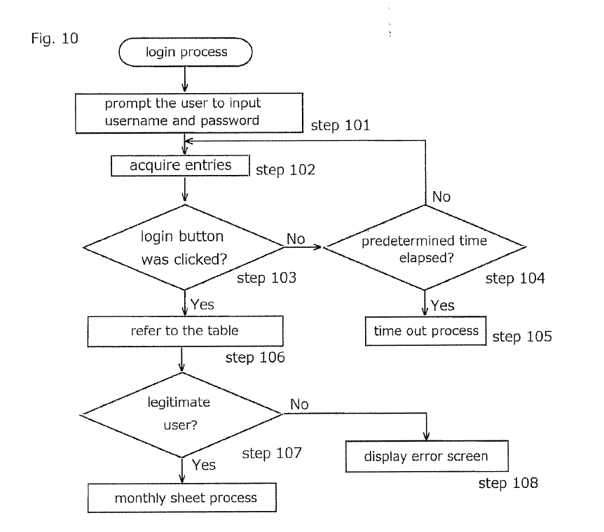

FIG. 4 indicates login screen (FIG. 4(a)), error screen (FIG. 4(b)), and monthly sheet (FIG. 4(c)) which appears when login is successfully done. FIG. 10 indicates the flowchart of login process.

In order to use the calendar apparatus one or more embodiments of the claimed invention produces, the user get access to this application program. Then the calendar apparatus displays login screen (FIG. 4(a)). User name box and password box which prompt the user to input username and password are displayed in the login screen (step 101). When the user input them, the calendar apparatus obtains entries (step 102), and judges whether login button was pressed or not (step 103). Until the login button is pressed (“No” at step 103), the calendar apparatus judges whether a predetermined time elapsed or not (step 104). And until the predetermined period of time elapsed (“No” at step 104), step 102, step 103, and step 104 are repeated. When the predetermined time elapsed (“Yes” at step 104), time out process is executed (step 105). Time out process is for example, the process in which the apparatus does not accept the input of the user from now. Or the process in which the apparatus goes back to step 101 and redoes login process.

When the login button is clicked (“Yes” at step 103), the apparatus refers to the correspondence relationship (for example, the table) which associates the user name and the password (step 106), and judges whether the user is legitimate user or not (step 107). When the user is legitimate (“Yes” at step 107), the apparatus displays the monthly sheet (FIG. 4(c)). When the apparatus judges the user is not legitimate, displays the error screen (FIG. 4(b)) (step 108). And the apparatus prompts the user to re-enter.

FIG. 4(c) shows the monthly sheet of March 2013, and in this case the first day of the code is set on March 1. The apparatus displays the date (and a day of the week) which corresponds to the annual code. And the apparatus displays the daily records which correspond to the date. In case “daily records” is unregistered, the column is a blank as shown in FIG. 4(c). Even if it is before the day comes, it is possible to input “daily records” of the day. Therefore, a future schedule can be inputted and used. The monthly sheet shown here contains 39 clickable buttons (or areas). Those are 31 annual code buttons, previous month button for moving to the previous month, next month button for moving to the next month, this month button for moving to this month, annual sheet button for moving to the annual sheet, record search button for moving to record search, 2 memo columns (memo 1 and memo 2), update button for updating memos. “Previous month” is the month previous to the month which is displayed now. “Next month” is the month next to the month which is displayed now. “This month” is the month to which the day when the user operates this calendar apparatus belongs.

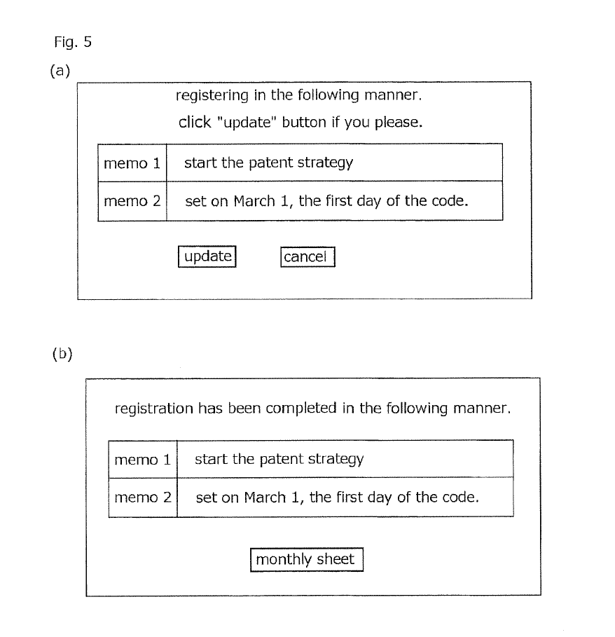

The column of the bottom of FIG. 4(c) is the memo column. It is prepared so that the memo 1 (for example, schedule of the future), the memo 2 (for example, the past record), and two memos can be inputted. This memo column will receive the input from a keyboard, if the user clicks the area concerned. You may make the apparatus display a software keyboard for a touch-panel input. If an input finishes, the user will move to the confirmation screen shown in FIG. 5 (a) by pushing the updating button prepared near the memo column.

### Monthly Sheet Process

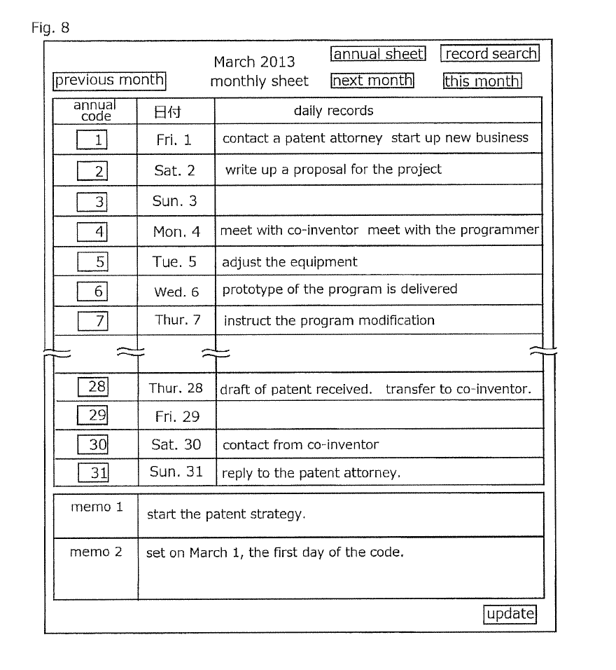

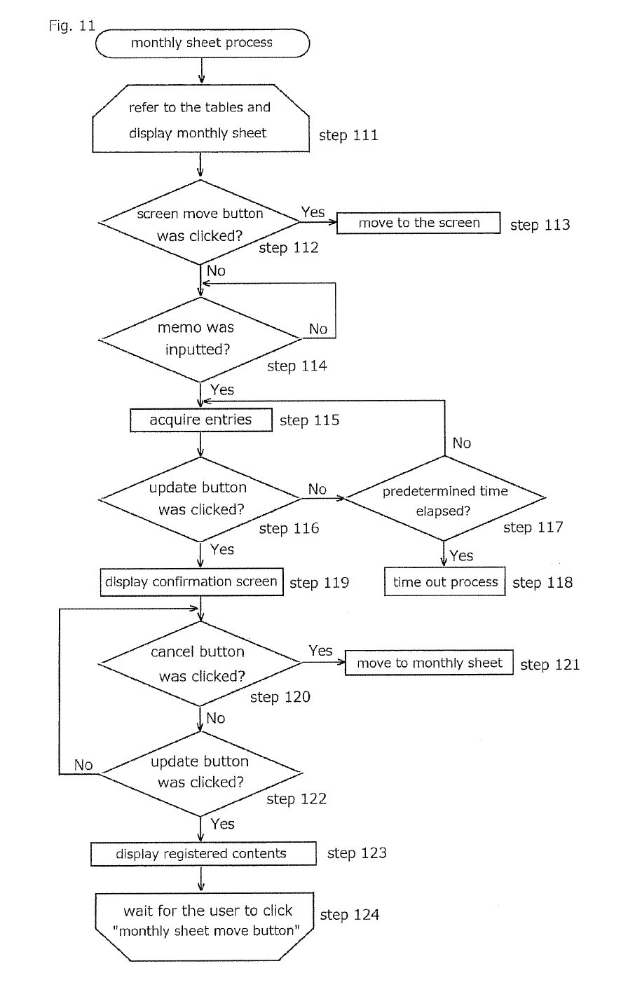

FIG. 11 is a flow chart which shows display process and memo input process of monthly sheet. This processing not only in when it succeeds in login processing (“Yes” at step 107), It is the processing started also when it has moved to monthly sheet by clicking monthly sheet button from other screens, and performs as loop processing from step 111 to step 124. First, with reference to each table (correspondence table 251 between annual code and date, and correspondence table 252 between date and daily records), the apparatus displays the monthly sheet of the month to which the day when the user operates belongs, as shown in FIG. 4 (c). FIG. 4 (c) shows the state where no daily records are inputted. If it is in the state where much daily records was already inputted, many records are displayed on the column as which daily records is displayed, as shown in FIG. 8.

Next, it is judged whether the screen changes button was clicked or not (step 112). Here, the screen changes buttons contain this month button, next month button, previous month button, annual sheet button, record search button and annual code button shown in FIG. 4 (c) and FIG. 8. Record search button is the button for moving to a record search screen, and annual code button is the button for moving to daily record screen. In this meaning, record search button and annual code button are also included in the screen changes button.

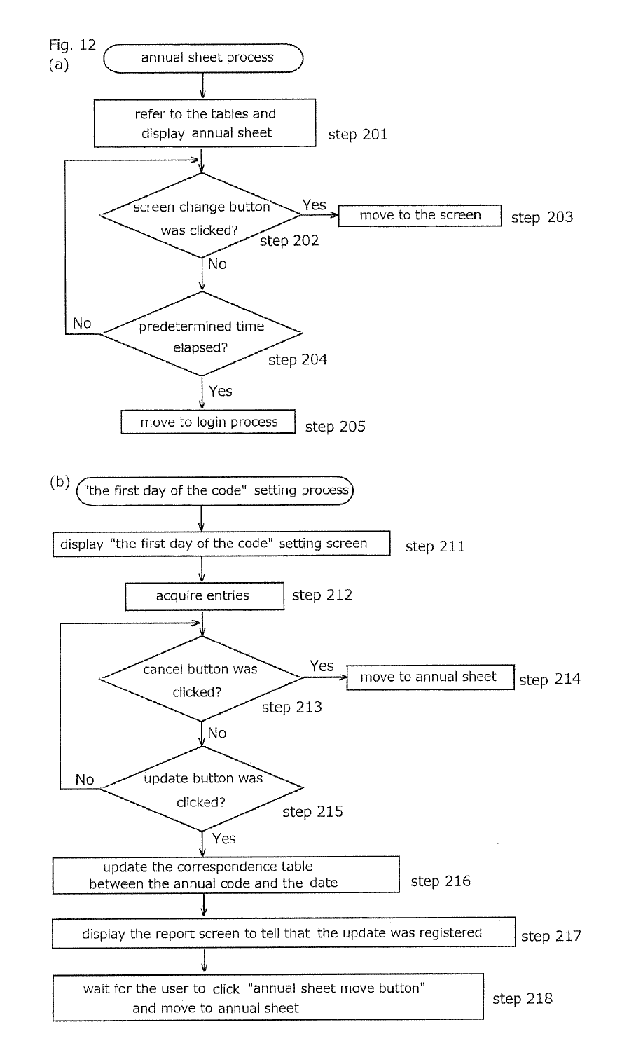

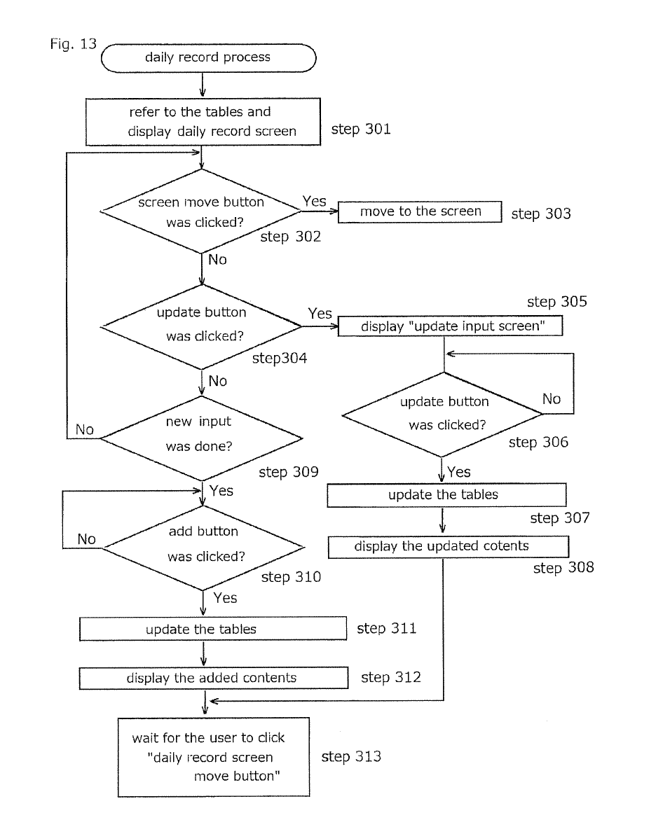

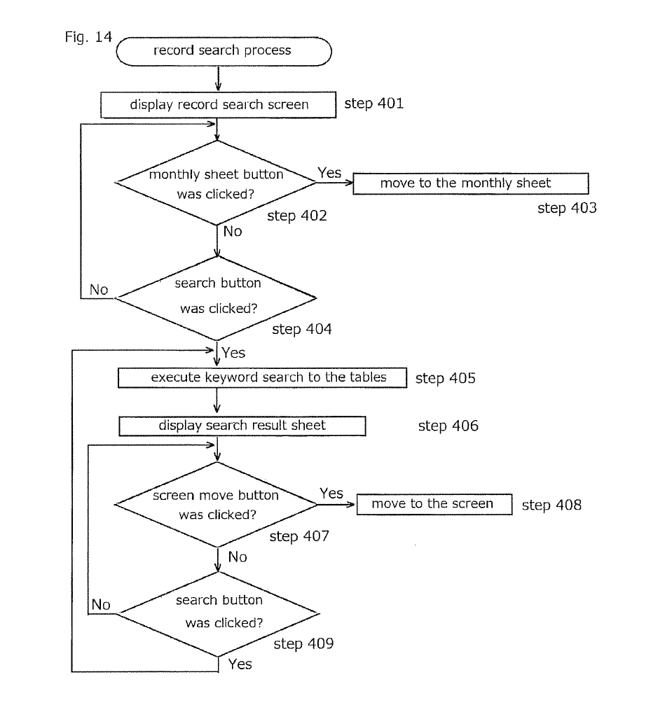

If the screen changes button are clicked (“Yes” at step 112), the apparatus will move to the screen concerned (step 113). If the user clicks this month button, next month button or previous month button, speaking concretely, with reference to each table, the apparatus will display that monthly sheet of the month concerned, respectively (step 111). Moreover, if the user clicks the annual sheet button, the apparatus will perform annual sheet processing shown in FIG. 12. If the user clicks the record search button, the apparatus will perform record search processing shown in FIG. 14. If the user clicks the annual code button, the apparatus will perform display processing (FIG. 13) of daily record screen of the date which belongs to the year of the monthly sheet concerned among the dates corresponding to the annual code concerned.

In case of “No” at step 112, the apparatus waits whether to have carried out the memo input to the memo column (the memo 1, the memo 2) of FIG. 4 (c) for a predetermined period (step 114). If a memo input is made, the contents of an input will be acquired (step 115) and it will be judged whether update button was clicked (step 116). Before update button is clicked (“No” at step 116), It is judged whether predetermined time passed (step 117). If predetermined time passes (“Yes” at step 117), the same timeout processing as step 105 of FIG. 10 will be performed (step 118). In this case, when the user wants to continue use of the calendar apparatus, it is necessary to redo from login processing. When predetermined time has not passed (“No” at step 117), acquiring the contents of an input (step 115) and the judgment of whether update button was clicked (step 116) are repeated. When the update button is clicked (“Yes” at step 116), a confirmation screen (FIG. 5 (a)) is displayed (step 119). Next, the apparatus judges whether the cancellation button of FIG. 5 (a) was clicked (step 120), if clicked (“Yes” at step 120), the apparatus will move to monthly sheet (step 121), and progress to step 111. After step 111, the loop processing to step 124 is performed as mentioned above.

When the cancellation button of FIG. 5 (a) is not clicked (“No” at step 120), it is judged whether the update button of FIG. 5 (a) was clicked (step 122). When judged that update button is not clicked (“No” at step 122), the judgment of whether cancellation button was clicked (step 120) and the judgment of whether updating button was clicked (step 122) are repeated. Although illustration was omitted, timeout processing is performed when update button is not clicked by the judgment of whether update button was clicked (“No” at step 122). That is, progress of predetermined time is supervised like step 117, and if it goes through predetermined time, it times out.

If judged with update button having been clicked (“Yes” at step 122), the contents of the memo to register will be displayed (step 123). Then, the apparatus waits to push button “moved to monthly sheet” (step 124). Desirably, in step 124, when button is not clicked for a long time, the same timeout processing as mentioned above is performed.

FIG. 5 shows the confirmation screen in the case of inputting a memo into the memo column (the memo 1, the memo 2) prepared in monthly sheet. When the user finishes an input in FIG. 4 (c) and clicks update button, the screen changes to the screen shown in FIG. 5 (a). The apparatus displays the contents inputted into the memo 1 and the memo 2, respectively, and prompt the user to check of registering. This screen has update button and cancellation button. If cancellation button is clicked, the screen will return to original monthly sheet, and re-input becomes possible. The memo concerned will be memorized by the predetermined storage area if update button is clicked. Then, the screen shown in FIG. 5 (b) is displayed and the contents of registration are displayed. The user checks the contents of registration anew, seeing the display of FIG. 5 (b), clicks monthly sheet button, and moves to monthly sheet. Here, the confirmation screen of FIG. 5 (b) was prepared in piles, in order that the user could, to be sure, recognize having clicked update button rather than pushing cancellation button in FIG. 5 (a).

FIG. 8 shows monthly sheet after inputting some daily records. It is the monthly sheet in March, 2013 which is shown in FIG. 8. The movement button to the previous month, the movement button to the next month, the movement button to this month, the movement button to annual sheet, and the movement button on a record search screen are formed in the topmost part. To the bottom of it, annual code, days and months, and daily records (here only title) are matched, and it is shown by tabular form. Here, registration of daily records by March 31 is made. Having contacted the patent attorney for having started new business on March 1 and a patent strategy, having contacted the common inventor and the programmer, etc. are recorded. It is recorded on the memo 1 of the lowest column, saying “A patent strategy is started”, and is recorded on the memo 2, saying, “March 1 was set up as first day of the code.”

### Annual Sheet Processing and First Day of the Code Setting Processing

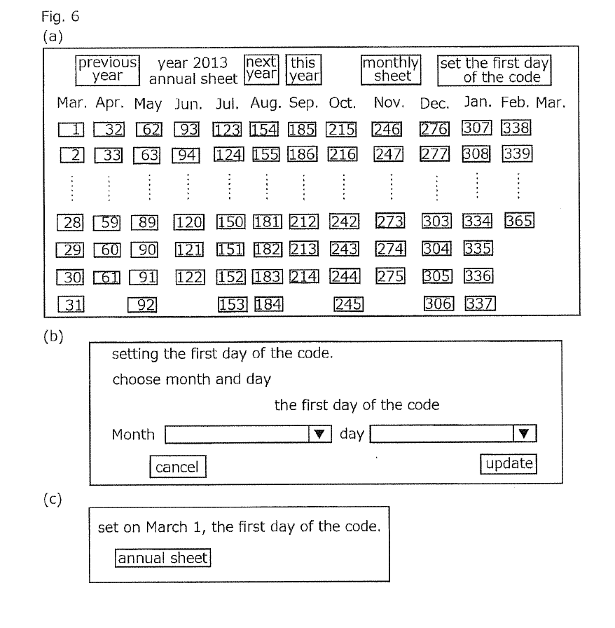

FIG. 12 is a flow chart (FIG. 12 (a)) which shows annual sheet processing, and a flow chart (FIG. 12 (b)) which shows first day of the code setting processing. The annual sheet processing shown in FIG. 12 (a) is the processing started by clicking annual sheet button prepared in other screens (daily record screen, monthly sheet), or it is the processing started by clicking the previous year button or the next year button prepared in annual sheet. First, annual sheet is displayed with reference to the correspondence table 251 between the annual code and the date. In moving to annual sheet from daily record screen or monthly sheet, the apparatus displays annual sheet of the year to which the day concerned or the month concerned belongs. In clicking previous year button (or next year button) and moving, the apparatus displays annual sheet of the previous year (or next year) of the year which was being displayed immediately before. The contents were shown in FIG. 6 (a).

FIG. 6 (a) shows annual sheet in the 2013 year about the case where first day of the code is March 1. The numbers from 1 to 365 surrounded by the rectangle show annual code, and each of these rectangles is clickable. And if the user clicks it, the screen of the apparatus will change to daily record screen of the day corresponding to the annual code of the year concerned. Since first day of the code is the day March 1, i.e., the beginning of the month, here, annual sheet in the 2013 year in 12 months goes over from March, 2013 to February, 2014. In case that first day of the code is not on March 1 but on March 15, annual sheet will be displayed as a sheet in 13 months, i.e., from Mar. 15, 2013 till Mar. 14, 2014. As for annual code in FIG. 6 (a), annual code buttons in March are perpendicularly located in a line from 1 to 31, and those in April is located in a line from 32 to 61. And it ranks with May and June similarly and annual code 365 will be assigned on February 28 in February which is the last month.

In addition to these annual code buttons annual sheet is provided with four clickable buttons. They are previous year button, the next year button, the monthly sheet movement button, and the first day of the code setup button. If the user clicks the previous year button once, the screen will move to annual sheet in the 2012 year. If the user clicks the previous year button twice, the screen will move to annual sheet in the 2011 year. If the user clicks the button 3 times, the screen will move to annual sheet in the 2010 year, and so on. In this embodiment, it goes back in the past till the 1901 year. Similarly, if the user click the next year button once, the screen can move to annual sheet in the 2014 year, and it can move toward the future by click two or more times. It can move in this embodiment till the 2199 year.

If the user clicks the monthly sheet movement button, the screen of the apparatus will move to the monthly sheet of the month when the time on which the user operates this calendar apparatus, belongs. In order to move to monthly sheet of other months, after moving to monthly sheet, the user clicks the next month button or the previous month button, and the screen will change. As other way to move to other months, moreover, in annual sheet, the user clicks the previous year button or the next year button several times (if necessary), and move to a desired year, and he clicks one of the annual code buttons which belongs to the desired month, and move to a daily record screen, then clicks monthly sheet button. In this way he can move to the desired month (refer to FIG. 3).

The apparatus judges whether one of the screen change buttons prepared in annual sheet (FIG. 6 (a)) was clicked or not (step 202), and when clicked (“Yes” at step 202), the apparatus changes the screen, and the screen move to the screen concerned (step 203). The screen change buttons in here are concepts in a broad sense like step 112 of FIG. 11. So, annual code button and the first day of the code setup button are included in it. If the user clicks annual code button, the screen will move to daily record screen. If the user clicks the first day of the code setup button, the screen will move to a first day of the code setting screen (FIG. 6 (b)).

As the flow chart shown in FIG. 12, when the screen changes button are not clicked (“No” at step 202), two judgments of step 202 and step 204 are repeated until it supervises progress of predetermined time (step 204). If predetermined time passes (“Yes” at step 204), the apparatus will move to login processing (step 205). It is for carrying out the same processing as timeout processing and preventing the input by others.

FIG. 12 (b) is a flow chart which shows first day of the code setting processing. This processing is started by clicking the “first day of the code setup” button from annual sheet. First, a “first day of the code setting screen” is displayed. This screen is a screen as which a user is made to input or choose the day of choice of first day of the code, as shown in FIG. 6 (b). It is displayed as “A first day of the code setup is performed. Please choose the day and month to wish.” The column of the month and the column of the day are prepared and each column is provided with list display button (black-lacquered inverse triangle). If a user clicks list display button prepared in the column of the month, the small window for displaying in a list opens and in it the names of the month “Jan., Feb., Mar., Apr., May, Jun., Jul., Aug., Sep., Oct., Nov., and Dec.” may be perpendicularly located in a line. If list display button of a day is clicked after a user chooses the month, a small window opens in the display part of the column of a day, and the days which belongs to the chosen month will be perpendicularly located in a line, and will be displayed. For example, if a user chooses March (Mar.), the apparatus will display from “1” to “31” on the list of days. If a user chooses April (Apr.), the apparatus will display from “1” to “30” on the list of days. February 29 cannot be chosen as first day of the code. It is because February 29 comes only once in four years, while annual code in calendar apparatus concerning this invention is premised on the cycle of one year.

If a user inputs or chooses the first day of the code, calendar apparatus (first day of the code setting processing means 204) acquires the inputted contents (step 212). Next, the apparatus judges whether cancel button (FIG. 6 (b)) was clicked (step 213), and when clicked (“Yes” at step 213), the apparatus moves to annual sheet (step 214). Then, the apparatus judges whether update button (FIG. 6 (b)) was clicked (step 215), and before being clicked (“No” at the step 215), the judgments of step 213 and step 215 are repeated. If update button is clicked (“Yes” at step 215), based on updated first day of the code, “the correspondence table 251 of annual code and date” will be rewritten (step 216), the screen (FIG. 6 (c)) which tells a user that renewal of first day of the code was registered is displayed (step 217). And the apparatus waits for a user to click annual sheet button, and moves to annual sheet (step 218). If a user clicks cancel button, without clicking update button, the apparatus will return to the display of annual sheet, without rewriting annual code.

FIG. 6 (c) shows the screen which tells a user that renewal of first day of the code was registered. The movement button to annual sheet and the message of “having updated first day of the code on March 1.” are displayed. The user checks that the first day of the code has been updated as desired, and the user clicks the movement button to annual sheet, and continues other work. In order to perform a first day of the code setup for the second time, what is necessary is to push again the first day of the code setup button displayed on annual sheet and just to move to first day of the code setting screen (FIG. 6 (c)).

### Daily Record Processing

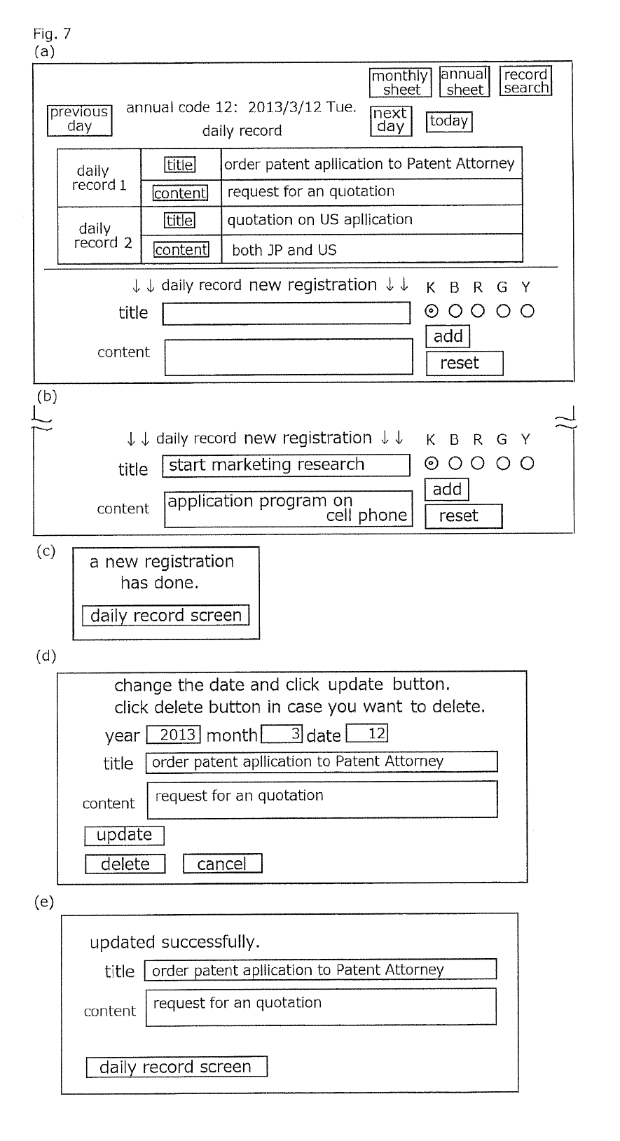

FIG. 13 is a flow chart which shows daily records processing (the display processing, an input process, additional processing, update process). This processing is started by clicking annual code button from other screens. Moreover, in daily record screen, the previous button or the next day button is clicked, this processing is started. FIG. 7 shows the screen about daily record screen and its input. In daily records processing, the correspondence table 251 between the annual code and date the correspondence table 252 between the date and the daily records are referred to first, then daily record screen (FIG. 7 (a)) is displayed (step 301). As shown in FIG. 7 (a), daily record screen displays the contents of daily records which is matched with the date concerned by the upper half. And the content is already registered into the correspondence table. The daily record screen provides the input column for carrying out new registration of daily records in the lower half. FIG. 7 (a) shows daily record screen in case two affairs are already registered as daily records on Mar. 12, 2013. In the upper part of a screen, the movement button to monthly sheet, the movement button to annual sheet, the movement button on a record search screen, the movement button to the previous day, the movement button to the next day, and the movement button to today are formed. Moreover, it is displayed as “annual code 12: 2013/3/12 Tue. daily records” as a title (it is not clickable) of this daily record screen.

In the flow chart shown in FIG. 13, next to step 301, the apparatus judges whether the screen changes button was clicked (step 302), and when clicked (“Yes” at step 302), the screen moves to the screen concerned (step 303). The screen changes buttons in here are previous day button, next day button, today button, monthly sheet button, annual sheet button, and record search button as shown in FIG. 7 (a). If the user clicks the movement button to monthly sheet, the screen will move to monthly sheet in March, 2013. If the user clicks the movement button to annual sheet, the screen will move to annual sheet in the 2013 year. If the user clicks the movement button to the previous day, the screen will move to daily record screen on Mar. 11, 2013. If the user clicks the next day button, the screen will move to daily record screen on Mar. 13, 2013. If the user clicks the today's button, the screen will move to daily record screen of the date to which the time at which the user performed the operation belongs.

In the middle of daily record screen, the contents of daily records already registered into the date concerned are displayed. Here, since two affairs are registered, daily record 1 and daily record 2 are displayed according to a title and contents, respectively.

The lower part of daily record screen is provided with the column of daily record new registration. The entry column of a title and the entry column of the contents are prepared. The character of a title can be chosen from 5 colors (black, blue, red, green, yellow). A title character can be chosen by choosing one of five radio buttons (K, B, R, G, Y). The column of the contents is prepared a little more greatly than the entry column of a title. Near the column of the contents, Addition button and Reset button are formed as clickable buttons.

In the flow chart shown in FIG. 13, next to step 302, the apparatus judges whether the update button was clicked (step 304), and when clicked (“Yes” at step 304), the apparatus displays an update input screen (FIG. 7 (d)) (step 305). Here, the update buttons are button of the “title” and button of the “contents” which were provided near daily record 1 or the daily record 2 shown in FIG. 7 (a). These are clickable and if the user clicks one of them it is possible to update the contents of the daily records concerned. In addition, although button of a “title” and the button of the “contents” were considered as the update button in FIG. 7 (a), you may make the column (domain) clickable. In that case, the user can click the column and input newly. As shown in FIG. 7 (d), when carrying out renewal registration of the already inputted contents, the date is also made applicable to updating. It is convenient when the contents of the daily records concerned are performed on a different day from the planned date.

The apparatus judges whether update button was clicked (step 306), and if it came to be clicked (“Yes” at step 306), the contents of updating concerned will be registered into the correspondence table 252 between date and daily records (step 307). And the apparatus displays the screen (FIG. 7 (e), step 308) which tells the user that the updating was done, and prompts the user to click the movement button to daily record screen (step 308). Then, the apparatus waits for the user to click the movement button to daily record screen (step 313). If the button is clicked, the screen will return to the beginning (step 301) of daily records processing.

In the judgment (step 304) of whether the update button was clicked, in case being No, the apparatus judges whether the input to the new registration screen in the lower half of daily record screen of FIG. 7 (a) was made (step 309). When a new input is not carried out (“No” at step 309), three judgments of step 302, step 304, and step 309 are repeated. When a new input is made (“Yes” at step 309), the apparatus judges whether Addition button was clicked (step 310). @When Addition button is clicked (“Yes” at step 310), the apparatus carries out additional registration of the contents concerned, and adds the additional registration at the correspondence table 252 between date and daily records (step 311). FIG. 7 (b) shows daily record screen in the case of carrying out new registration as the 3rd affair of daily records of the date concerned. The apparatus processes new registration, if the user fills in the title and the contents in which he or she is going to carryout new registration, and clicks the addition button as shown in the figure. And the apparatus displays the screen (FIG. 7 (c)) which tells to the user that the new registration is done, and urges the user to move to daily record screen (step 312). Then, the apparatus waits for the user to click the movement button to daily record screen (step 313). If the movement button is clicked, the apparatus returns to the beginning (step 301) of daily records processing. If reset button (FIG. 7 (b)) is clicked, the apparatus returns to daily record screen, without registering new daily records.

FIG. 7 (c) shows the screen displayed when Addition button is clicked, after inputting the contents which the user wants to register newly. The apparatus displays the “daily record screen move button” and the message that a new registration has done. When the user checks that message and clicks the movement button to daily record screen, the apparatus moves to the daily record screen concerned. That is the similar screen to FIG. 7 (a). Three columns daily record 1, daily record 2, daily record 3 are displayed. And the user can check that three affairs were registered.

In addition, in FIG. 7 (a), near daily record 1, daily record 2, - - - , daily record n (n is an integer), a “title” and the “contents” are displayed, respectively. They are clickable buttons. If the user clicks the button of the “title” or the “contents”, the apparatus displays the screen (FIG. 7 (d)) similar to FIG. 7 (b), and the alteration registration of the title of daily records or the contents becomes possible.

In addition to the case of the new registration of FIG. 7 (b), the column of time change is also prepared in the updating screen of FIG. 7 (d). Thereby, in the case of renewal registration, change of time is possible, and it is convenient for renewal registration in case the execution day differs from the schedule date.

“Deletion button” is further formed in the updating screen of FIG. 7 (d). By clicking this button, the daily record (a title and the content matched with the date) is deleted. FIG. 7 (e) shows the screen which tells the user that renewal registration was made successfully.

Even if it is a case where renewal registration of already registered daily records is carried out, or even if it is a case where new daily records registration is carried out, the correspondence table 252 (FIG. 2 (c)) between date and daily records is rewritten.

### Record Search Processing

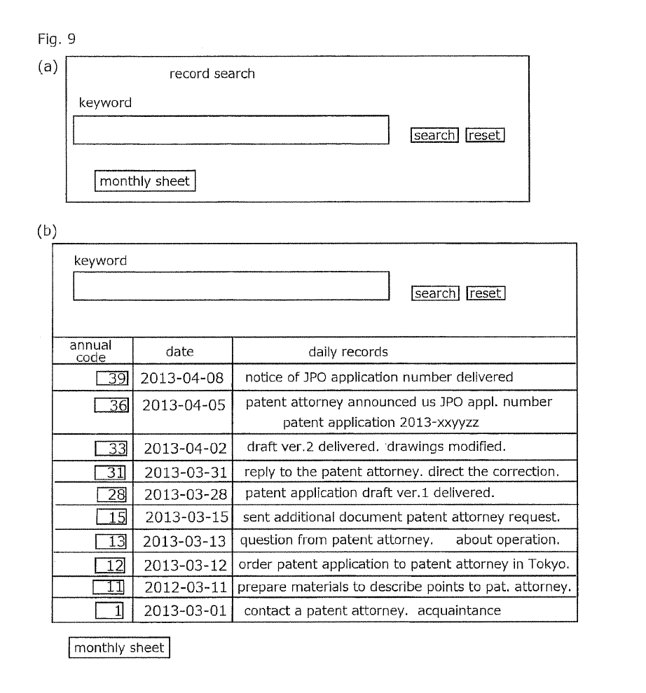

FIG. 14 is a flow chart which shows record search processing. FIG. 9 shows a record search screen (FIG. 9 (a)) and a search-results sheet (FIG. 9 (b)). The movement button to a record search screen is formed in monthly sheet (FIG. 4 (c), FIG. 8) or daily record screen (FIG. 7 (a)), record search processing begins by clicking the button.

First, a record search screen (FIG. 9 (a)) is displayed (step 401). The keyword input column, Search button, Reset button, and the monthly sheet movement button are formed in a record search screen. The apparatus judges whether monthly sheet button was clicked (step 402), and when clicked (“Yes” at step 402), the screen changes to monthly sheet (step 403). The apparatus judges whether search button was clicked (step 404) when monthly sheet was not clicked (“No” at step 402), and when not clicked (“No” at step 404), two judgments, step 402 and step 404, are repeated. When Search button is clicked (“Yes” at step 404), retrieval by keyword is performed to the correspondence table 252 between date and daily records (step 405). In record search processing, the apparatus applies retrieval by keyword by making into targeted search the titles recorded as daily records, and all the contents. Here, record search processing means acquires what the user inputted into the keyword input column of FIG. 9 (a), and it is used as the keyword of search. When reset button (FIG. 9 (a)) is used, the keyword input column will be returned to the blank and the contents inputted anew after that are used as a keyword. This reset processing is omitted drawing on the flow chart of FIG. 14 in order to avoid complicacy.

Next, the list of results to which retrieval by keyword was applied is displayed as a search-results sheet (FIG. 9 (b)) (step 406). The keyword input column for redoing retrieval by keyword, search button, and reset button are formed in the upper part of the search-results sheet. When the user looks at the list of search-results sheets, and thinks that it differs from the search results for which the user asks, a keyword can be inputted anew and search can be redone. Moreover, the user can operate refine research which carries out search refinement. After displaying a search-results sheet (step 406), the apparatus judges whether the screen change button was clicked (step 407), and when clicked (“Yes” at step 407), the screen moves to the screen concerned (step 408). Here, the screen change buttons are the monthly sheet movement button and annual code button prepared in the lowest column of the search-results sheet. In the example of FIG. 9 (b), ten annual code buttons are displayed, they are clickable. When the user clicks one of them, the screen moves to the daily record screen of the date which corresponds. In the lowermost part of the screen of FIG. 9 (a), and the screen of FIG. 9 (b), monthly sheet button is prepared, and if the monthly sheet button is clicked, the screen will move to monthly sheet this month (the month to which the day when the user uses this apparatus belongs).

When not clicked by the judgment of whether the screen change button was clicked (“No” at step 407), the apparatus judges whether search button was clicked (step 409). When search button is not clicked (“No” at step 409), the judgment of step 407 and the judgment of step 409 are repeated. When search button is clicked (“Yes” at step 409), for the correspondence table 252 of date and daily records, retrieval by keyword is performed based on the inputted keyword concerned (step 405), and a search-results sheet is displayed (step 406).

Daily records narrowed down as search results is matched with the date and annual code by the search-results sheet shown in FIG. 9 (b), and is displayed on it. Therefore, it is convenient to calculate the days between two dates to which two related daily records happened. For example, when FIG. 9 (b) is read, the patent application number has been told on Apr. 5, 2013, and annual code corresponding to it is “36.” And the day which requested patent application is on Mar. 12, 2013, and annual code corresponding to it is “12.” Since 36−12=24, it can calculate easily that it was 24 days from a request to patent application completion.

Here, date of ten affairs has hit. And it has stood in a line in order so that oldest date may become the bottom and the latest date may turn up. It is made to correspond to date, annual code is displayed, and a title and the contents (one sentence of the beginning) are displayed about daily records. It sorts in order of date and has ranked with the descending order also in annual code here. When daily records straddles the change of a year, it is no longer a descending order. Moreover, it is possible that the same annual code appears two or more times. It is because the same annual code is used for other years. Even in such a case, annual code is the date concerned (strung with date), and confusion cannot be produced. Therefore, if the user clicks annual code which is clickable button, the screen can move to daily record screen of the right date.

About the Meaning of Calendar Apparatus (Especially Annual Code) for Elderly People

In the clause of the solution means, meaning as a self-reflection tool and a project progress management tool was already described. Here, calendar apparatus of this invention is added from a viewpoint which elderly people use. For elderly people, especially exceeding 70 years old, forgetfulness may also bring about a body bad condition. An old man may have the displeasure that it can remember and meets—it comes out and cannot remember easily. If the displeasure will continue for one day, loss of appetite, an energy fall, etc. may be brought about. There is a record tool appropriately compensated with the fall of memory to it, if using it can make customary, good condition can be maintained and energy and volition can maintain sufficient state.

On the newspaper in May, 2013, the example of the 93-year-old man engaged in agriculture in the farm village in Japan was introduced. The person began keeping ten-year-diary from the time of 70 years old, and he keeps ten-year-diary with the 3rd volume now. A ten-year diary is a diary continuously kept for ten years by one volume, and is the diary made so that it might be easy to do what written referring to what you did to—and the same season nine years ago one year and two years ago. Since agricultural work repeats the same agricultural work as the time same every year especially, it is suitable for considering a thing a year cycle. This farmer can continue doing thinking continuous by continuing keeping this diary, and can be continuing the life unrelated to dementia.

Even when it is not a farmer, when elderly people are concerned with a positive target at an annual event in the society and the organization to whom he belongs, it is thought that the thinking continuous by considering a thing a year cycle can be continued. And this calendar apparatus makes it possible to employ efficiently with reference to the past a year cycle over tens of years at the present, since it began to use not only in ten years, and to have with future. For example, semantic attachment to which the memo 1 prepared in monthly sheet is said as the schedule (writing matter to the future) of the future, and the memo 2 is said as the past record (teachings obtained from the past) can be carried out, and it can use.

### EXPLANATION OF A MARK

10 computer
11 input device
12 display device
20 ASP server
30 personal computer
31 mobile phone (cell phone)
32 smart phone
40 Internet

What is claimed is:

1. Calendar apparatus, realized by software, which matched with date, annual code which is the code in a cycle of one year which assigned the specific day of the year as the 1st day, and assigned to all the dates in order, said calendar apparatus comprising;
monthly sheet processing means which indicates by list about specific years, daily records which is daily occurrence, correspond to said annual code and said date;
annual sheet processing means which indicates by list, annual code button which displays said annual code as clickable button about a specific year;
first day of the code setup means which sets first day of the code to the date a user wishes;
daily records processing means which processes initial registration and renewal registration while displaying that with which it already registered of said daily records, said processing is started by clicking said annual code button;
record search means which performs a search to said daily records, makes the search results correspond to said annual code and the said date, and displays them.

2. The calendar apparatus of claim 1, wherein the apparatus has the said correspondence relation between said annual code and the said date as a correspondence table of annual code and date.

3. The calendar apparatus of claim 1, wherein the apparatus has the said correspondence relation between the said date and said daily records as a correspondence table of date and daily records.

4. The calendar apparatus of claim 2, wherein the apparatus has the said correspondence relation between the said date and said daily records as a correspondence table of date and daily records.

5. The calendar apparatus of claim 1, wherein the said records processing means also makes date applicable to change.

6. The calendar apparatus of claim 1, wherein the said apparatus further comprising;
login processing means which checks that a user has just authority;
timeout processing means which does not permit use of the user beyond it, when said calendar apparatus is operating and there is progress of predetermined time;
and in not permitting use of the user beyond it by timeout processing means, a user requires performing login by login processing means again.

7. The calendar apparatus of claim 1, wherein the file output of the said monthly sheet which the said monthly sheet processing means displays, or the search results which the said record search means displays is carried out, and a user is made to acquire.
